(19) United States
(12) Patent Application Publication
(10) Pub. No.: US 2003/0170452 A1
(43) Pub. Date: Sep. 11, 2003

(54) Masking device and method

(76) Inventors: Daniel Hansen, Los Angeles, CA (US); Brian J. Kramer, Los Angeles, CA (US)

Correspondence Address: Steven B. Courtright, BANIAK PINE & GANNON, Suite 1200, 150 N. Wacker Drive, Chicago, IL, 60606-1606, US

(21) Appl. No.: 10/383,146

(22) Filed: Mar. 6, 2003

Related U.S. Application Data
(63) Continuation-in-part of application No. 10/094,575, filed on Mar. 8, 2002.

(51) Int. Cl. B32B 7/12

(52) U.S. Cl. 428/343

(57) ABSTRACT

A masking device including a substantially rigid body, the body having an underside and adjoining first and second edges and an L-shaped adhesive portion positioned on the underside adjacent to one or more of the first and second edges and methods for making, using and removing the masking device to mask corners of flat surfaces such as windowpanes, walls, ceilings and floors.

This application is a continuation-in-part of U.S. patent application Ser. No. 10/094,575, filed Mar. 8, 2002.

### FIELD OF THE INVENTION

The apparatus and method of the present invention relates to the field of finishing work i.e., painting, staining and lacquer. In particular, the present invention relates to a masking device that protects flat corner surfaces when applying finishing work to adjacent areas. The masking device is used to protect flat surfaces such as windowpanes, walls, or floors during the application of finishing work to adjacent areas. The invention includes a method of making and using the device.

### BACKGROUND OF THE INVENTION

When applying finishing materials such as, for example, paint, stain, or lacquer, workers typically protect adjacent windowpanes, walls and floors and other surfaces before applying the materials by the use of a covering referred to as masking. One example of masking is masking tape. Before applying paint adjacent to a surface area that must be shielded, the surface area is covered by dispensing lengths of masking tape from a roll or dispenser and applying the length of masking tape to the surface adjacent the area to which the paint is to be applied.

For example, if an area of wood trim of a window frame adjacent a glass windowpane is to be painted, a portion of the glass window surface adjacent the trim is covered with masking tape to prevent paint from coming into contact with the glass surface. In this example, masking tape would be dispensed from a roll and preferably fitted along the edges and corners of the glass windowpane adjacent the wood trim. The process of fitting the masking tape along the windowpane and particularly into the corners thereof can be especially difficult and is time consuming if a worker wishes to do quality work. After finishing work has been completed, the masking tape is removed and disposed of; leaving the glass surface underneath free of paint, stain or lacquer or other applied finishing materials. Because masking tape will bond to glass and other flat surface areas to which it has been applied (especially when left adhered to such surfaces over a period of time), it is difficult and time consuming to remove masking tape after the finishing work has been completed. For this reason, painters must often spend a great amount of time using a razor blade or their finger nails to scrape away masking tape after finishing work has been completed. In fact, the process of masking and the subsequent removal of masking tape can be more time consuming and difficult than the actual application of the finishing work itself.

To address the problem of time consuming and arduous masking methods, reusable masks have been developed which are intended to reduce the amount of labor. One example of such a device is a rigid paint mask for covering a window. This mask is guided into position by contact with the molding around the window, and is held in place by a suction cup mounted underneath each corner of the mask. The suction cups attach to the glass surface of the window. A primary drawback of this type of mask is that they are only cost-effective if a very large number of identical items are being painted. This is due partially to the specificity of the mask, with each mask being manufactured for one particular size and shape of window and partially to the relative expense of making these masks, all of which require either custom manufacturing or the assembly of several parts. Also, after these suction cups have been used they must be cleaned.

An example of an inexpensive masking device includes a mask made out of a flexible and thin plastic sheet with adhesive applied to its underside or along all of its exterior edges. The flexible plastic sheets tend to adhere to window surfaces due to the inherent adhesive quality of the plastic from which they are manufactured. However, because of the flexibility and thin cross-section of these sheets, they are difficult to quickly detach from their backing sheets and apply to a window. Moreover, since virtually the entire underside of this masking sheet is coated with a pressure-sensitive adhesive it tends over time to permanently bond to glass and other surfaces. Thus, like masking tape, the user of this plastic masking sheet must also often spend considerable time scraping it off of a windowpane with either a razor or a finger nail. For the same reason, these flexible plastic sheets are difficult to reposition or remove after they have been adhered to glass or other surfaces.

The flexible nature of this plastic masking sheet enables it to be used on flat as well as uneven surfaces (i.e., surfaces that are raised, not level, uneven or bumpy). While these plastic sheets can (like masking tape) be used to mask uneven surfaces (such as, for example, light switches or electric outlets), their flexible nature has inherent drawbacks when being used to mask flat surface areas such as glass. First, because the device easily wrinkles or bends, the user is typically required to use two hands to detach it from its backing sheet, and align or reposition it on the surface to be masked. Second, it is difficult to jam or forcefully insert the masking device over the corners of surfaces that have surrounding edges with overhanging material(s) or crevices. Corners of windowpanes, for example, commonly have edges that contain overhanging debris that has been left from previous paint jobs. It is difficult to insert flexible paint masks under such debris. Likewise, it also difficult to jam or forcefully insert this flexible plastic sheet into narrow crevices or grooves that commonly exist around the edges of windowpane corners that must be masked. Also, flexible masks tend to wrinkle or bend when the user tries to apply them adjacent to corners that have surrounding uneven edges or edges with some debris on them. Third, the flexible nature of this masking device renders it ineffective in assisting the painter in removing any masking tape that he has applied over the masking device.

Masking tape is frequently used in combination with other flexible masking device(s) to mask-off the entire exterior edges of a surface that needs to be shielded from the finishing material. Painters often apply masking tape over portions of these flexible masking devices, or the entire masking device, so as to completely mask-off the area adjacent to which paint is to be applied. Yet, because the masking device is flexible and can be easily torn it cannot be grabbed by the user and used in a tab-like manner to help pull away any overlapping strips of masking tape. Moreover, this flexible plastic sheet is not specifically designed so that a portion of it will, for example, protrude out from underneath overlapping portions of masking tape. If any portion of this masking device happens to protrude out from underneath any overlapping portion of masking tape, it is difficult for the user to get a digit or tool between the underside of the masking device and the masked surface. It is difficult for a user to get a digit or tool between the underside of this masking device and a surface to which it has been adhered because, among other reasons, the entire underside (or all exterior edges) of this masking device has been coated with pressure-sensitive adhesive, and the plastic sheets tend to bond with flat surfaces such as glass. Furthermore, flexible masks are easily torn. Tearing may occur when, for example, a user must detach the masking device from a window for either disposal or repositioning.

Another type of existing masking device includes flexible triangle masks that have an underside that is coated with pressure-sensitive adhesive and/or adhesive edges. These masks are packaged in a roll and come attached to a backing sheet. This masking device is intended to be used in combination with masking tape to mask 90′ degree corners. Because these triangle masks are made out of a thin and flexible material, they experience all of the above-referenced drawbacks associated with flexible plastic sheets. In addition, since the materials of these flexible triangle masking sheets have memories they tend to curl up or wrinkle especially after they have been removed from their backing sheets or other surfaces to which they have been adhered. For this reason, these triangle masking sheets are difficult to handle. Moreover, the triangle configuration of this masking device creates several drawbacks. First, the triangle configuration makes it difficult to mask corners that are not surrounded by perfectly smooth and flat edges or precise 90 degree right angles. When either of the two edges around a 90 degree corner are not smooth, or do not form a precise 90 degree right angle, the triangle masking device will either leave gaps, bend or wrinkle.

The triangle masking device must be used in combination with masking tape in order to mask-off the entire exterior edges of a windowpane. However, these flexible triangle masking devices are not designed to assist workers in removing any masking tape that might overlap them. No portion of the triangle masking device is, for example, designed to specifically protrude out from under overlapping masking tape and therefore cannot be used in a tab-like fashion to facilitate the pulling away of any overlapping masking tape. Virtually all commercially available masking tape used by painters is 2″ wide or less. Yet, these flexible triangle masks are not specifically designed so that any portion of them will protrude out from under masking tape that is 2″ wide or less. Moreover, even if any portion of this triangle masking device happens to protrude out from underneath any overlapping masking tape, it is difficult for the worker to get a digit or tool between the underside of the masking device and the surface it has been used to mask. It is difficult for a user to get a digit or tool between the underside of this masking device and a flat glass surface to which it has been applied because, among other reasons, the entire underside (or all exterior edges) of this triangle masking device has been coated with pressure-sensitive adhesive, and the mask is flexible and therefore tends to form a bond with glass.

Moreover the placement of the adhesive on the underside of the triangle masking device also creates problems. The adhesive is applied to the entire underside of these triangle masking devices, or, at a minimum, along all portions of the triangle's three exterior edges. Because virtually the entire underside (or all exterior edges) of this triangle masking device is coated with adhesive, the masking device tends to stick to a user's fingers and is therefore difficult to handle. The placement of adhesive on virtually the entire underside of these masks also makes them difficult to reposition or remove after it has been applied to a surface. Workers are frequently required to use a finger nail or a razor blade to scrape this masking device off of glass and other flat surfaces. Finally, because these triangle masking devices are packed on a roll, they are cumbersome to handle, ship and store for retail purposes.

Another type of existing masking device is a thin and flexible “L-shaped” mask that comes on a roll or in a deck. Virtually the entire underside of this masking device is coated with a pressure-sensitive adhesive; only small portions of inner two legs of this masking device include non-adhesive zones. Because the L-shaped masking device is made out of a flexible plastic or paper material, they exhibit all of the above-referenced drawbacks of flexible masking sheets and the flexible triangle shaped masking device. Moreover, all of the above-referenced disadvantages associated with the triangle masking device configuration apply to this L-shaped masking device. In addition, since the non-adhesive portion of the underside is positioned within the inner acute portion of the “L-shaped masks” it is difficult for the user to grasp and handle this masking device.

As with the triangle masking device, the L-shaped masks must also be used in connection with masking tape to mask-off the entire exterior edges of a windowpane. However, these L-shaped masking devices are not designed to assist a user in removing any masking tape used to overlap the device. No portion of this L-shaped masking device is, for example, designed to specifically protrude out from underneath any overlapping masking tape and therefore cannot be used in a tab-like manner to remove any overlapping masking tape. Moreover, even if some portion of this L-shaped masking device did happen to protrude out from underneath any overlapping masking tape, it is difficult for the worker to get a digit or tool between the underside of the masking device and the flat surface it has been used to mask. It is difficult for a user to get a digit or tool between the underside of this masking device and a flat glass surface to which it has been applied because, among other reasons, virtually the entire underside of this flexible L-shaped masking device has been coated with pressure-sensitive adhesive and therefore tends to form a bond with glass.

For the foregoing reasons, a demand therefore exists for an improved device and method for masking surfaces in preparation for finishing work which is inexpensive and easy to apply and remove. The present invention satisfies the demand.

### SUMMARY OF THE INVENTION

The present invention provides an improvement for masking the corners of flat surface areas, such as windowpanes, walls, floors and ceilings which overcomes the above-referenced drawbacks of other existing masking devices.

One aspect of the present invention provides a masking device including a substantially rigid body, the body having an underside and adjoining first and second edges and an adhesive portion positioned on the underside adjacent to one or more of the first and second edges.

The masking device may include an adhesive portion that includes a pressure-sensitive adhesive. The masking device adhesive portion may be formed adjacent the first and second edges as an L-shaped area. The masking device body may include an arcuate surface on the first edge. The body may include an arcuate surface on the first edge and the second edge. The body may include a stepped surface on the first edge. The masking device body may include a stepped surface on the first edge and the second edge. The masking device first edge and second edge may form a 90-degree angle. The masking device first edge and the second edge may be adapted to form an angle to match that of a corresponding corner of a windowpane. The body may include a third edge and a fourth edge, the third and fourth edges being free of adhesive. The masking device body may include a tab portion for grasping by a user. The tab portion may be formed on a corner of the body opposite the first and second edges. The body may include a first leg portion adjacent one or more of the first edge and the second edge. The adhesive portion may be positioned relatively inboard of the first leg portion. The body may include a third edge and a fourth edge and wherein a second leg portion is positioned adjacent one or more of the third edge and the fourth edge.

Another aspect of the present invention provides a deck of masking devices including a plurality of stacked masking devices. Each of the plurality of stacked masking devices includes a substantially rigid body, the body having a top side and an underside and first and second adjoining edges and an adhesive portion positioned on the underside adjacent to one or more of the first and second adjoining edges.

The deck may include a first one of the plurality of stacked masking devices positioned on top of a second one of the plurality of stacked masking devices. The adhesive portion of the first one of the plurality of stacked masking devices may be positioned in contact with the topside of the second one of the plurality of stacked masking devices. The plurality of stacked masking devices may include more than two of the masking devices. The deck may include a bottom sheet temporarily affixed to a bottom one of the plurality of stacked masking devices.

Another aspect of the present invention provides a method of masking flat surfaces (such as windowpanes) and a method for removing the masking device and any partially overlapping strips of masking tape after the finishing work has been completed. The window includes a frame to which finishing work will be applied and at least one windowpane positioned within the frame. The windowpane is flat and has a plurality of corners that must be masked. The method includes positioning a masking device in each of the plurality of windowpane corners such that a gap is left between each of the masking devices and applying masking tape to span the gaps such that an outside edge of the windowpane is completely masked. The method also includes positioning the masking device into the corners of a windowpane and applying masking tape so that it only partially overlaps the device and therefore there is a protruding section of the device that can be used like a tab to assist the user in beginning to remove partially overlapping strips of masking tape.

A method of manufacturing masking cards according to the present invention is provided by coating an underside of a card with an adhesive. A top side of a thin sheet is coated with a release agent in an L-shaped pattern. The underside of the card is laminated to the top side of the thin sheet. A line of separation is formed in the thin sheet along an L-shaped pattern by the use of a die cutter, for example. A pattern of tipping glue is applied to a top of the card and a plurality of the cards is formed into a deck.

A method of masking a window and removing the masking materials from a window with a masking device, the window including a frame and at least one flat windowpane positioned within the frame, the windowpane having a plurality of corners according to the present invention is provided by a) removing a masking device from a deck of masking devices, b) removing an L-shaped portion of a thin sheet from an underside of the masking device, c) exposing an adhesive of the underside of the masking device, d) adhering the masking device underside of the masking device into one of the plurality of windowpane corners such that a gap is left between each of said masking devices, d) repeating steps a-d until all of the plurality of corners are masked by a masking device, e) applying masking tape to span said gaps such that an outside edge of the windowpane is completely masked, and f) wherein each masking device is at least partially overlapped with masking tape, and optionally including the step of removing the masking device and overlapping masking tape by grasping the portion of the masking device that protrudes out from underneath the masking tape to facilitate removing the strips of masking tape that have been adhered to the outer edges of the window.

The invention provides the foregoing and other features, and the advantages of the invention will become further apparent from the following detailed description of the presently preferred embodiments, read in conjunction with the accompanying drawings. The detailed description and drawings are merely illustrative of the invention and do not limit the scope of the invention, which is defined by the appended claims and equivalents thereof.

### BRIEF DESCRIPTION OF THE DRAWINGS

The above-mentioned and other features and advantages of this invention, and the manner of attaining them, will be further understood by reference to the following description of an embodiment of the invention taken in conjunction with the accompanying drawings, wherein:

FIG. 1 shows a bottom view of one embodiment of the invention;

FIG. 2 shows a cross-sectional view of FIG. 1;

FIG. 3 shows a top exploded view of five masking devices of the present invention in a stack configuration;

FIG. 4 shows a cross-sectional view of a stack or deck of the masking devices; and

FIG. 5 shows another embodiment of the present invention in a cross-sectional view;

FIG. 6 shows another embodiment of the present invention in a cross-sectional view;

FIG. 7 shows another embodiment of the present invention and a cross-sectional view;

FIG. 8 shows another embodiment of the present invention in a cross-sectional view;

FIG. 9 shows another embodiment of the present invention in a cross-sectional view;

FIG. 10 shows a bottom view of the invention of FIG. 8;

FIG. 11 shows an embodiment of a method of the present invention;

FIG. 12 shows a flow chart illustrating an embodiment of a method of making the device according to the present invention;

FIG. 13 shows an alternate embodiment of a method of manufacturing the device according to the present invention; and

FIG. 14 shows an alternate embodiment of a method of manufacturing the device according to the present invention.

### DETAILED DESCRIPTION OF A PRESENTLY PREFERRED EMBODIMENT

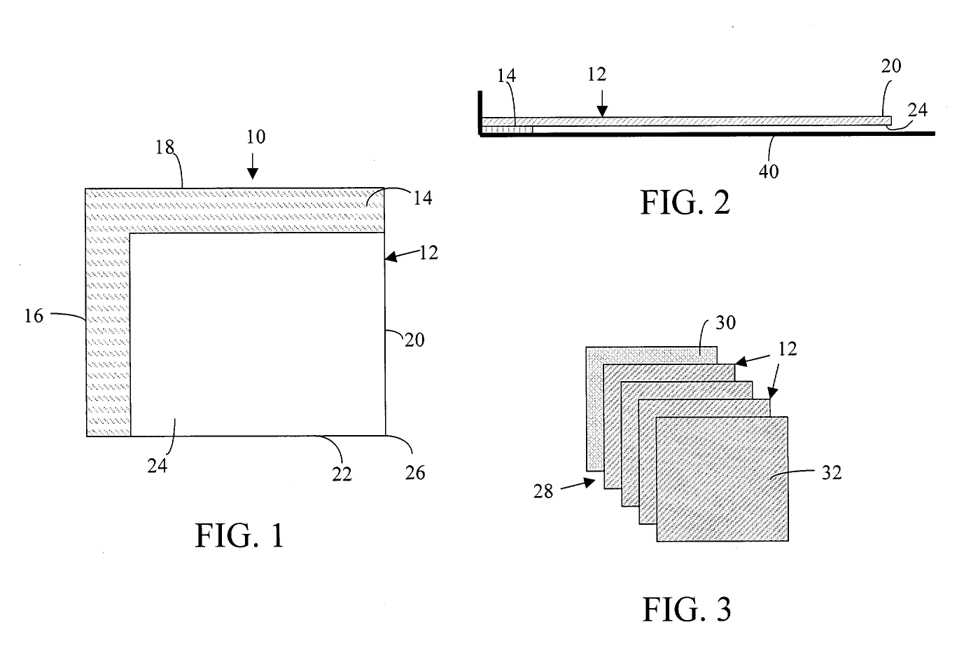

Beginning with the invention shown in FIG. 1, a masking device is shown generally at 10. In broad overview, the device 10 includes a body 12 and an adhesive portion 14.

The body 12 is preferably made of a rigid, substantially rigid or semi-rigid material. Examples of body material include heavy paper, a heavy paper with a coating (e.g., silicon, polymeric or plastic), cardboard, paper-polymer composites, plastic, polymeric composites, and other materials. In one preferred embodiment, the body is made of a silicon-coated paper stock about 7 mil in thickness and about 90 lb. paper stock. For the purpose of the present invention, “substantially rigid” refers to a stiffness that falls between paper ordinarily used in a computer laser printer or printed books (which is approximately 20 lb.) or Post-It Notes, masking tape or flexible plastic films and unyieldingly rigid. It will be understood that the material from which the body is made preferably possesses paint-resistant properties. The body 12 may be made of such a resistant material, coated with a paint-resistant material, or otherwise provided with such a resistant material. In other words, the body 12 should resist absorbing paint or resist the penetration of paint or paint solvent through the body material and consequently coming into contact with the protected surface (not shown). The body 12 may have any suitable shape. In one preferred embodiment, the body 12 has an overall rectangular or square shape for fitting into the corner of a flat windowpane. The body 12 may include a right triangle shaped portion, sized to fit into a window corner. Depending on the surface to be masked, the body 12 may have other shapes such as angled or curvilinear.

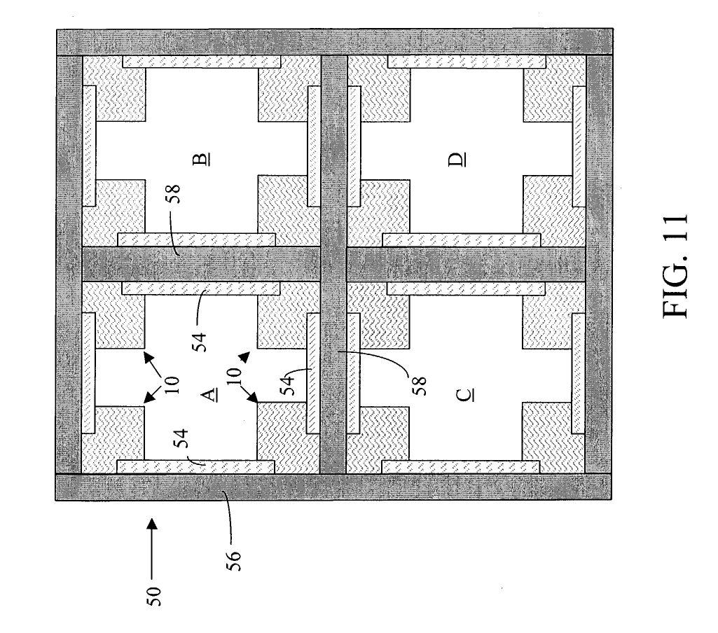

As will be explained more fully below, when used in a windowpane, the size of the body 12 is preferably less than half the dimension of the windowpane to which it is attached. Preferably, the body 12 is sized such that four individual devices are used in a windowpane without overlapping. For example, if a windowpane is being masked which glass measures 18″×12″, each mask device 10 may be sized 3″×3″ or 4″×4″, for example, such that when four masking devices are used, there is effective masking of the corners, some coverage of the windowpane glass surface and no overlap therebetween. Preferably, the masking device will be greater than 2″ inches wide. As a result, when the masking device is used in combination with masking tape that is 2″ wide or less to completely mask-off the exterior edges of a windowpane, a portion of the masking device, which has no adhesive applied on that section of the device's underside, will protrude out from underneath the masking tape as shown in portion 10 of FIG. 11. Because the device will preferably be greater than 2″ inches wide and will have pressure-sensitive adhesive applied in a L-shaped pattern along only two of its exterior edges (as shown in portion 14 of FIG. 1 or portion 46 of FIG. 10 ), the device is designed to assure that when masking tape has been applied over it that a portion of the device will protrude out from underneath the masking tape that can be easily grasped by inserting a digit or tool under the adhesive-free area of the underside of the masking device for removal from the window.

The adhesive portion 14 is positioned on an underside 24 of the body 12. One embodiment of the present invention contemplates the use of a pressure-sensitive adhesive that adheres to a windowpane or the like in such as fashion as to be easily removed upon completion of the finishing work. In other words, the adhesive 14 should not permanently affix the body 12 to the protected surface, mar the surface or otherwise cause a defacement of the protected surface contacted. Other suitable adhesives may be used, so long as they include the property of providing temporary adhesion of the device 10 to a surface. In one embodiment, the adhesive portion 14 does not have a significant cross-sectional thickness. The adhesive portion 14 may thus be a thin layer or area of adhesive material, double-sided adhesive tape or the like.

In one embodiment of the invention, the adhesive portion 14 is applied or positioned adjacent to or along two adjoining edges 16, 18 of the body 12. The adhesive portion 14 may be in the form of strips of adhesive material or an adhesive area. The two adjoining edges 16, 18 are positioned in a corner of a flat windowpane and pressed to affix the adhesive 14 onto the glass of the windowpane. The two free edges 20, 22 opposite the adjoining edges 16, 18 are free of adhesive so that a user may easily slip a digit or tool underneath the free edges of the masking device and remove the body 12 from the protected surface after painting is completed, by prying or levering, for example. The edges 16, 18, 20, 22 may be tapered or angled or curved as well as perpendicular to the underside 24 or topside 32 of the body 12.

The adhesive portion 14 may be applied to other portions of the underside 24 of the body 12. The adhesive portion 14 is positioned in such a fashion to leave a corner 26 free of adhesive to facilitate removal of the body 12 after it has been used.

As shown best in FIG. 2, the body 12 may be a flat, thin planar body in cross-section. The adhesive portion 14 is shown positioned along one of the adjoining edges 16. It will be understood that the thickness of the adhesive portion 14 is exaggerated for illustrative purposes.

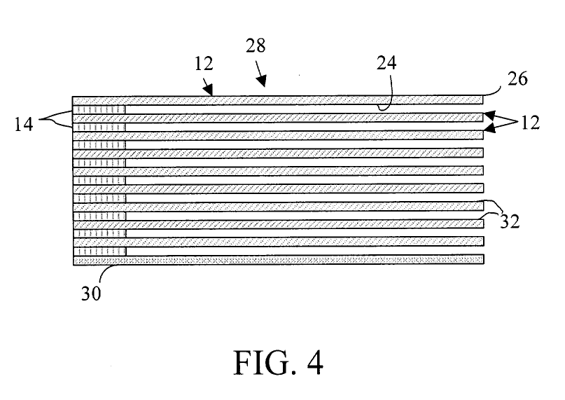

In a preferred embodiment, as shown in FIGS. 3 and 4, a plurality of bodies 12 are stacked into a deck 28 to save space, for example, and provide a simple method of shipping, storing, carrying and dispensing bodies when performing a masking operation. The adhesive portions 14 on the bodies 12 adhere to topside 32 of an adjacent body to form the stacked deck 28. A protective sheet 30 may be used on the underside 24 of the bodies 12 to protect the adhesive portion thereon from becoming fouled with dust and other contaminants. The protective sheet 30 should be easily removed from the adhesive portion. Since, the thickness of the adhesive portion 14 is exaggerated for illustrative purposes, it will be understood that when stacked into a deck-like configuration as shown, there will be little or no gap between adjacent devices in the deck 28. In this manner, the devices are efficiently stored and transported. Due to the substantially rigid nature of each of the device bodies 12, the devices are easily separated from the deck 28, easily grasped, aligned and applied by the user to the flat surface area to be masked. For the same reason, the masking devices may be jammed or forcefully inserted and adhered to corners of flat glass surfaces on windowpanes that have surrounding areas with overlapping debris, crevices or cracks.

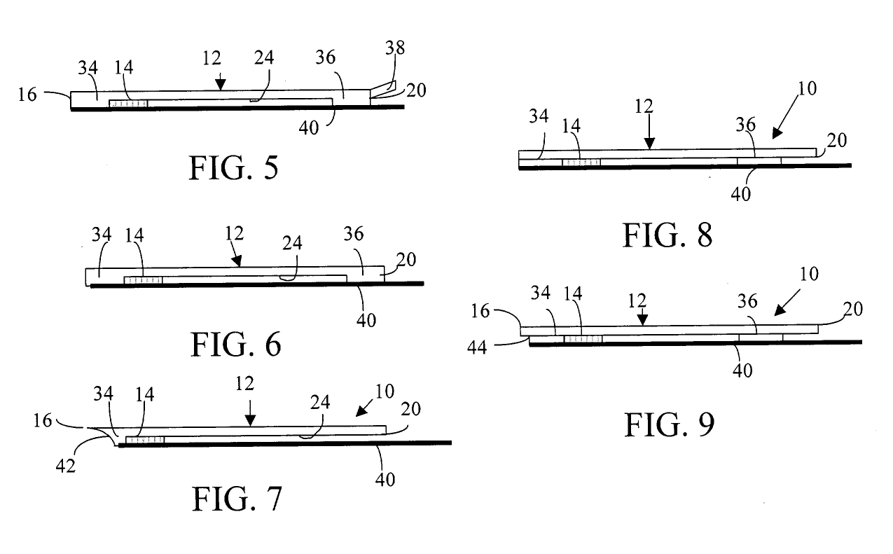

Turning to FIGS. 5 and 6, the body 12 may include a pair of legs 34, 36, which serve to space the body 12 from the protected surface 40. The legs 34, 36 may be extended or raised portions of the body 12 or the like. It will be understood that the protected surface 40 may be a flat windowpane, a flat wall surface, or any other flat surface that is masked to prevent adherence of paint to the protected surface. It will be understood that masking devices for masking flat surfaces is the preferred embodiment, but other surfaces may be contemplated. The legs 34, 36 are shown exaggerated for illustration purposes. A first leg 34 depends from the underside 24 of the body 12 outboard from the adhesive portion 14. A second leg 36 may depend from the underside 24 of the body adjacent one or more of the free edges 20, 22. The adhesive portion 14 should extend sufficiently from the underside 24 to contact the protected surface 40. A tab feature 38 (see FIG. 5) may be provided the free edge 20 to facilitate grasping by a user for easy removal of the device 10 from the protected flat surface area 40.

Turning to FIG. 7, an embodiment of the device 10 is shown with the first adjoining edge 16 including an arcuate surface 42. The arcuate surface 42 is sized and shaped to contact a corresponding adjacent curved surface (not shown) of a window frame or the like without gaps. The curved surface may be a portion of a window frame or a bead of window caulk or silicon material (not shown). The adhesive portion 14 may be positioned adjacent and inboard from the first leg 34 and extends from underside 24 sufficiently to contact protected surface 40.

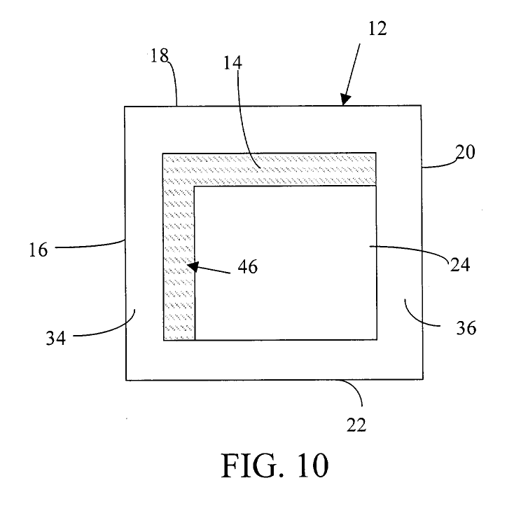

FIGS. 8 and 9 illustrate another embodiment of the device 10 of the present invention wherein the body 12 includes a first leg 34 and a second leg 36. The second leg 36 is positioned inboard from the first free edge 20 to position the first free edge 20 above the protected surface 40. In this manner, the first free edge 20 is easily graspable by the user and the device 10 is easily positioned and removed from the protected surface 40. FIG. 9 illustrates an embodiment of the device 10 of the present invention where the first leg 34 is positioned inboard from the first adjoining edge 16 to create a stepped surface 44. Similar to the arcuate surface of the device in FIG. 7, the stepped surface is sized and shaped to conform or cooperate with a corresponding surface of the flat windowpane or the like which the device 10 is positioned against.

FIG. 10 illustrates the position of the adhesive portion 14 on the underside 24 of the body 12 when elements (legs 34, 36, for example) of the device 10 are positioned at or near the edges 16, 18, 20, 22. In this embodiment, the adhesive portion 14 is an L-shaped area 46, which parallels the first and second adjoining edges 16, 18.

FIG. 11 illustrates one embodiment of a method of using the masking devices 10 of the present invention to mask corners of flat surface areas in combination with masking tape. A plurality of masking devices 10 may be used in masking a window 50. It will be understood that the present invention is not limited to masking flat windowpane corners. The device 10 may be used in masking other flat surfaces such as, for example, corners of a wall, ceiling, floor or the like. Because of the rigid, substantially rigid or semi-rigid nature of the masking device, however, the area to be masked should be a flat surface.

The exemplary window 50 includes four glass windowpanes A, B, C, D that have flat glass surfaces. One masking device 10 is applied to each corner of each of the windowpanes A, B, C, D. The devices 10 are of a shape to conform to the corners of the windowpanes and of a size so as to avoid overlap. After the masking devices 10 cover each corner of each of the windowpanes, conventional masking tape 54 can be used to mask the windowpane between the masking devices. As discussed above, the dimensions of the masking device will be greater than the width of at least 2 inch wide masking tape to facilitate grasping and removal of the masking devices. It can be seen that the masking device 10 and masking tape 54 mask the windowpane adjacent the window frame members 56 or the window grid members 58. After the finishing work is applied around the window frame members 56 and the grid members 58, the masking devices 10 and overlapping masking tape 54 may be removed by inserting a digit or tool under the adhesive-free portion of the masking device and pulling the device away from the windowpane. It may be possible to reuse the masking devices 10 in subsequent masking operations. However, it is preferable to use the devices in a disposable fashion.

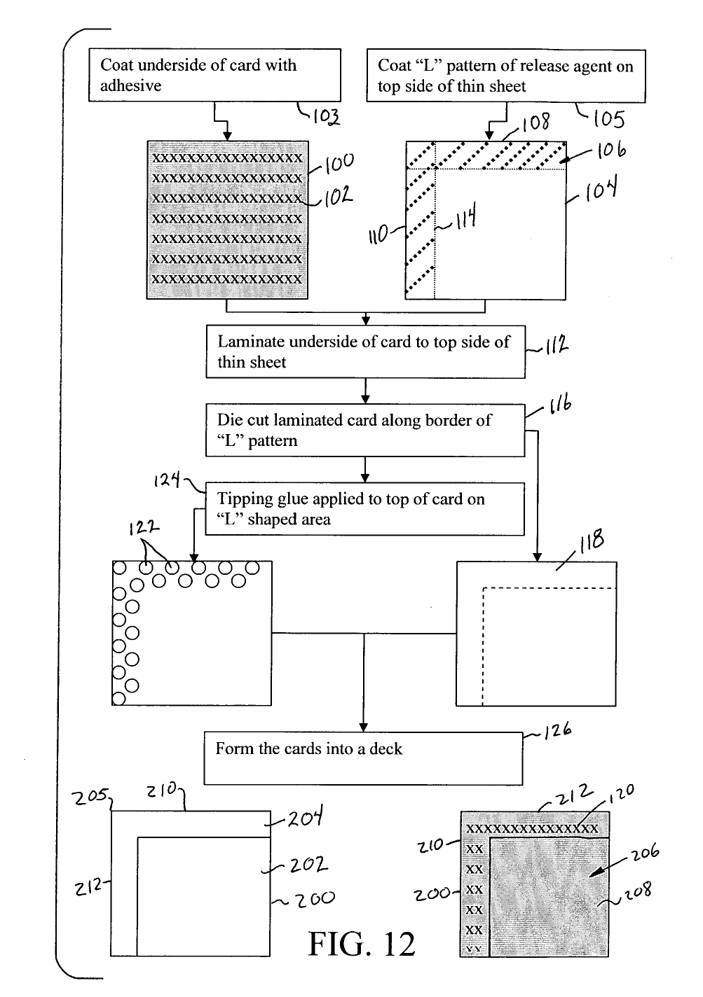

FIG. 12 is a flowchart illustrating one embodiment of a method of manufacturing masking devices of the present invention. It will be understood that any suitable method of manufacturing the masking devices is contemplated by the present invention. The exemplary method described is particularly applicable to a large volume manufacturing setting. While the present method will be described as for a single masking device, it will be understood that the process can be performed with large sheets of initial materials, each including multiple masking device portions, which are separated into separate masking devices and subsequently assembled, joined, guillotined or die cut into decks of masking devices. The large sheets of initial materials may be stacked one on top of another to enable multiple decks of masking devices to be created by guillotining or die cutting rectangular or square shaped objects out of the large sheets.

Initially, a body 100 of the masking device, which may be in the form of a card, is coated (block 103) on the underside with an adhesive 102, shown as “x”. The card may be made out of a substantially rigid heavy paper, a heavy paper with a coating (such as silicone), cardboard, paper-polymer composites, plastic, or polymeric composites. The applied adhesive 102 provides good adhesion to a glass surface, or the like, and releases cleanly from the glass, preferably without leaving residue. The card 100 may be formed of a heavy paper stock, coated heavy paper stock, cardboard, or plastic that is at least about 7 mil thick and provides a good barrier to the applied finish during use in masking a window or the like.

Separately, a thin sheet 104, preferably of paper, about 2 mil thick, is coated (block 105) on a top side with an L-shaped pattern 106 of release agent along two adjoining edges 108, 110 of the thin sheet of paper. The release agent may be any suitable release agent, such as, for example a silicon-based release agent. The adhesive coated card 100 and thin sheet 104 are laminated, bonded or fused together (block 112). Laminating, for purposes of this application includes any suitable method of attaching the card and thin sheet. Specifically, the underside of the card 100 is laminated, bonded or fused to the top side of the thin sheet 104. At this point, the device includes a body undercoated with an adhesive laminated to a thin sheet having an L-shaped pattern of release agent applied between the thin sheet and the adhesive coated underside of the card portion.

The laminated, bonded or fused device is die cut along the border 114 of the “L” pattern (block 116). The die cutting step provides for a line of separation along the border of the “L” pattern. Since the “L” pattern portion of the thin sheet 104 includes a release agent between the thin sheet and the adhesive coated card 100, it can be seen that it will be possible to remove from the laminate an L-shaped portion 118 of the thin sheet 104, exposing an L-shaped adhesive swath 120 of the underneath of the card 100. In use, it is the L-shaped adhesive swath 120 which is oriented to adhere to a corner of a flat windowpane or other flat surfaces such as a wall, ceiling or floor. For purposes of this application, the term L-shaped will contemplate an area shaped like an “L”, a triangle with a straight hypotenuse, arcuate hypotenuse, concave or convex hypotenuse or any similar figure including extending arms along the adjoining edges 16, 18 (see FIG. 1).

The adhesive swath 120 may be marked in any suitable fashion, for example with ink or die applied to the underside of the card, to indicate that this section of the masking device should be oriented into a window corner. The ink, or like, marker may be provided in a number of configurations, such as, for example, along an edge of the card, along an edge of the adhesive underside of the card or any other suitable position of the card which enables the user to determine the proper orientation of the masking device in use.

Tipping glue 122 is added in a pattern on top of the card 100 (block 124) aligned over the “L” shape so that when the laminates are stacked, the top of each card of the laminate will adhere to the bottom of each of the thin sheets 104 of the adjacent laminate when formed into a stacked deck (block 126).

In use, masking devices may be removed one at a time from the stacked deck. When a masking device 200 is lifted from the deck, the aforesaid assembly method provides a number of unique features to each device when removed from the deck. On the top side 202 of each device 200 will be thin material attached to the body in an L-shaped pattern 204. This pattern 204 may be used by the person masking to orient this corner portion 205 of the device towards the inner angle of the window because the exposed adhesive 120 is positioned directly below the pattern 204 on the underside of the body. This “L” pattern 204 of thin sheet material is held to the top side 202 by the tipping glue 122 applied before deck formation. The pattern of thin sheet material is permitted to separate from remainder of the material along the die cut, since the remainder of thin sheet of material is adhered to an adjacent device located above the device 200.

The bottom side 206 includes the remainder 208 of thin sheet material left after the L-shaped portion tears away. The underlying adhesive material 120 is revealed along the adjoining edges 210, 212 and will adhere to the window glass when applied thereto.

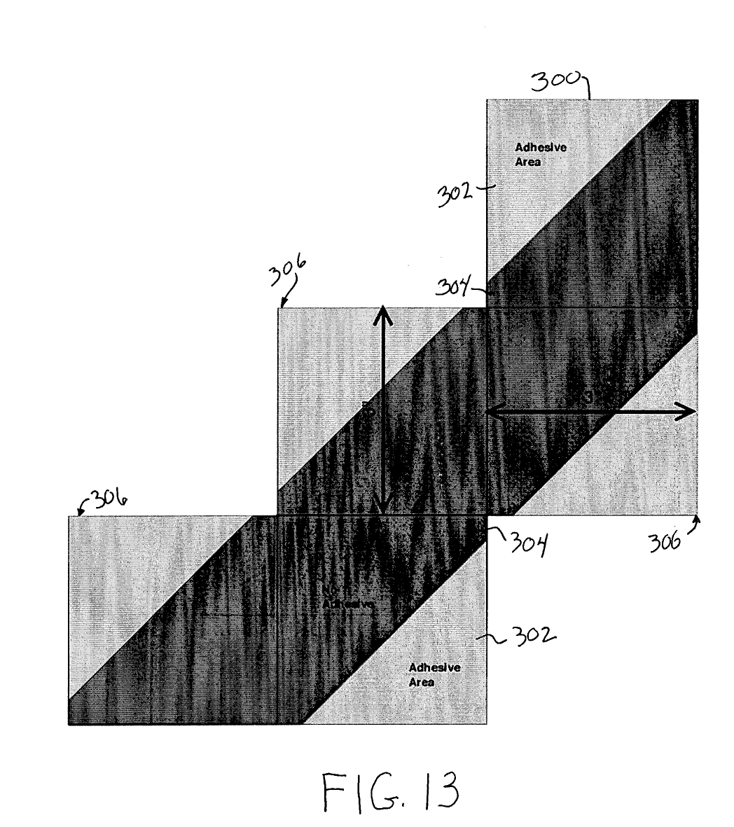

Alternate embodiments of the device of the present invention include a method of applying a coating, layer or the like, of adhesive to a masking device as shown in FIG. 13. The coating step shown above in FIG. 12 at block 103, involves tiling a plurality of card bodies 300. The bodies are arranged in a zigzag fashion, edge to edge. Adhesive is applied to the outer edges 306 leaving inner corners adhesive free. This creates on each body 300 an adhesive area 302 and an adhesive-free area 304. In another embodiment, the adhesive is applied in a single swath down the middle of the zigzag arranged bodies to provide essentially the same (but opposite) end result when the bodies 300 are separated.

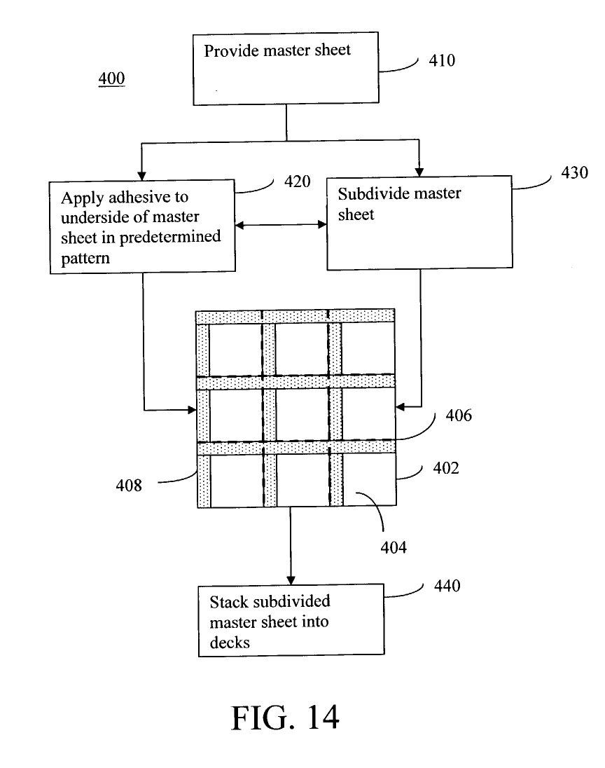

FIG. 14 shows yet another embodiment of a method 400 of manufacturing a device 404 according to the present invention. The method of manufacturing a device according to the present invention may begin with the provision of a master sheet 402 (block 410). If the final size of the device 404 is to be 3 inches square, the master sheet 402 may be 9 inches square, for example, to make 9 devices. As above, a preferred material for the master sheet 402 is a substantially rigid paper stock. The paper stock may be silicon coated on an upper surface and about 7 mil thick and about 90 lb. paper stock.

The next step may include either application of an adhesive 408 to an underside of the master sheet 402 or subdividing the master sheet into separate devices 404 (blocks 420 and 430). The order of these two steps is not critical to the inventive method. The adhesive 408 is applied to an underside of the master sheet 402 (or individual devices/card bodies) in a predetermined pattern, i.e., an L-shaped pattern or the like as described above. Optionally, an ink or die is applied on the card or underneath the L-shaped adhesive pattern to provide orientation thereof to the user. Another embodiment contemplates colored adhesive to provide orientation so that a user may apply the correct adhesive portion of the device into a window corner. Zone coating is one known technique for applying the adhesive. Preferably, the adhesive 408 is applied such that about a ¼ inches wide strip of adhesive material is positioned along two adjacent edges of each individual masking device at the end of the process. In other embodiments, the strip 408 is at most ½″ wide. In a further embodiment, the strip is less than ½″ wide in an L-shaped pattern along two adjoining edges of each masking device. The master sheets 402 may be separated into individual masking devices 404 by any suitable method. For example, the master sheets may be cut, guillotined, sawn, scored, or die-cut into individual masking devices. The lines of separation are indicated at dashed line 406. It will be understood that the example given is illustrative and not limiting in nature. The individual subdivided masking devices 404 may be stacked into decks for ease of storing, transport and use (block 440).

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

What is claimed is:

1. A masking device comprising:
a substantially rigid body, said body having an adhesive underside and adjoining first and second edges; and
a thin sheet positioned on said underside, said thin sheet including a separable L-shaped portion positioned along said first and second edges.

2. The device of claim 1 including a release agent disposed between said L-shaped portion and said underside to permit the separation of said L-shaped portion from said underside.

3. The device of claim 2 wherein said release agent is a silicon based release agent.

4. The device of claim 1 wherein said body is about 90 lb. paper stock.

5. The device of claim 4 wherein said body is formed of a silicon-coated paper stock.

6. The device of claim 4 wherein said paper stock has a thickness of about 7 mil.

7. The device of claim 1 wherein said thin sheet is formed of paper stock material having a thickness of about 2 mil.

8. The device of claim 1 wherein said body includes a top side with a pattern of tipping glue.

9. The device of claim 1 wherein a marker is provided on said underside substantially coinciding in position with said L-shaped portion.

10. The device of claim 1 wherein said first edge and said second edge together form about a 90 degree angle.

11. The device of claim 1 wherein said body is a rectangle having a width from about 2.1 inches to 5 inches.

12. The device of claim 11 wherein said width is about 3 inches.

13. A deck of masking devices comprising:
a plurality of stacked, releasably attached masking devices, wherein each of said plurality of stacked masking devices comprises a substantially rigid body, said body having an adhesive underside and adjoining first and second edges; and
a thin sheet positioned on said underside, said thin sheet including a separable L-shaped portion positioned along said first and second edges.

14. The deck of masking devices of claim 13 wherein said deck includes a first one of said plurality of stacked masking devices held on top of a second one of said plurality of stacked masking devices by an adhesive.

15. A method of manufacturing masking cards comprising:
coating an underside of a card with an adhesive;
coating a top side of a thin sheet with a release agent in an L-shaped pattern;
laminating the underside of the card to the top side of the thin sheet;
forming a line of separation in the thin sheet along the L-shaped pattern;
applying a pattern of tipping glue to a top of the card; and
forming a plurality of the cards into a deck.

16. A method of masking a flat windowpane with a masking device, the window including a frame and at least one flat windowpane positioned within the frame, the windowpane having a plurality of corners comprising:
a) removing a masking device from a deck of masking devices;
b) removing an L-shaped portion of a thin sheet from an underside of the masking device;
c) exposing an L-shaped adhesive pattern on the underside of the masking device;
d) adhering the masking device underside of the masking device into one of the plurality of windowpane corners such that the L-shaped adhesive pattern is positioned in the corner;
e) repeating steps a-d until all of the plurality of corners are masked by a masking device with gaps between each adjacent pair of masking devices; and
f) applying masking tape to span the gaps such that an outside edge of the windowpane is completely masked.

17. The method of claim 16 wherein each masking device is at least partially overlapped with strips of masking tape; and further including the step of:
g) removing the masking device and overlapping strips of masking tape by grasping a portion of the masking device protruding from underneath the masking tape to pull the masking device and overlapping masking tape away from the windowpane.

18. The method of claim 16 further comprising the step of providing the masking devices in a first width and providing the masking tape in a second width, the first width being greater than the second width so as to present a graspable portion of each masking device after applying strips of the masking tape over the masking devices, the graspable portion being free of adhesive.

19. A method of manufacturing masking cards comprising:
providing a master sheet of a masking device body material;
applying an adhesive material in a predetermined pattern to an underside of the master sheet; and
subdividing the master sheet into a plurality of individual masking devices wherein the predetermine pattern provides a strip of adhesive material along two adjacent edges of each of the plurality of individual masking devices.

20. The method of claim 19 wherein the predetermined pattern is an L-shaped pattern having a width of less than about ¼ inch.

21. The method of claim 19 wherein the master sheet is paper stock having a thickness between about 7 mil to 11 mil.

22. The method of claim 19 wherein each of the individual masking devices has a width from about 2.1 inches to 5 inches.

23. The method of claim 19 further comprising assembling the plurality of subdivided masking cards into decks, and wherein each deck comprises two or more masking devices.
